(19) United States
(12) Patent Application Publication
(10) Pub. No.: US 2011/0179345 A1
(43) Pub. Date: Jul. 21, 2011

(54) AUTOMATICALLY WRAPPING TEXT IN A DOCUMENT

(75) Inventors: Jay C. Capela, Santa Cruz, CA (US); Matthew T. Schomer, Santa Cruz, CA (US); Christopher E. Rudolph, Camas, WA (US)

(73) Assignee: APPLE INC., Cupertino, CA (US)

(21) Appl. No.: 12/688,622

(22) Filed: Jan. 15, 2010

(51) Int. Cl. G06F 17/00

(52) U.S. Cl. 715/209

(57) ABSTRACT

The described embodiments provide a system for formatting a document in a word processor. The system starts by performing at least one operation on an object in a section of text in the document. Before the operation is performed on the object, the text in the section of text is placed around the object in accordance with a first wrapping behavior. After performing the operation on the object, the system determines a second wrapping behavior for the text in the section of text around the object based on a location of the object in the section of text and a size of the object. The system then places the text around the object in accordance with the second wrapping behavior.

### RELATED APPLICATIONS

This application is related to U.S. patent application Ser. No. ______, titled “Automatically Placing an Anchor for an Object in a Document,” by inventors Jay C. Capela, Christopher E. Rudolph, and Matthew T. Schomer filing date ______ (attorney docket no. APL-P8614US1). This application is also related to U.S. patent application Ser. No. ______, titled “Automatically Configuring White Space Around an Object in a Document,” by inventors Jay C. Capela and Matthew T. Schomer, filing date ______ (attorney docket no. APL-P8615US1).

### BACKGROUND

1. Field

The described embodiments relate to techniques for formatting documents in a word processor. More specifically, the described embodiments relate to a technique for automatically wrapping text around an object in a document in a word processing application.

2. Related Art

Modern word processors include numerous features to assist with creating and editing documents. For example, virtually all word processors enable the placement and formatting of both text and objects, such as tables, images, and charts, in a document. Word processors can also enable a user to manually configure objects so that text near an object is arranged in a specified manner.

For example, in most word processors, a user can place an object in a section of text within a document and configure the object so that the word processor wraps the nearby text on all sides of the object. For example, FIG. 1 presents an exemplary document 100 where object 104 is configured so that the nearby text 102 is wrapped around all sides of object 104. Alternatively, a user can place an object in a section of text within a document and configure the object so that the word processor does not wrap the nearby text around all sides of the image. For example, FIG. 2 presents an exemplary document 200 where object 204 is configured so that the nearby text 202 is located above and below object 204, but is not wrapped around the sides of object 204.

Because objects are often resized and/or moved while a user is creating or editing a document, the object's original text-wrapping configuration can result in an undesirable arrangement of text around objects. For example, word processors can leave large amounts of white space around a moved or resized object. As another example, word processors can place text around a moved or resized object in a way that is unsightly and difficult to read. For example, FIG. 3 presents an edited version of document 100 where the right edge of object 104 has been extended to the right, making object 104 larger. As can be seen in FIG. 3, the word processor wrapping text on all sides of the resized object 104 results in a thin column of difficult-to-read text on the right side of object 104.

### SUMMARY

The described embodiments provide a word processor for formatting a document. During operation, based on a command from a user, the word processor performs at least one operation on an object in a section of text in the document. Before the operation is performed on the object, the text in the section of text is placed around the object in accordance with a first wrapping behavior. After performing the operation on the object, the word processor determines a second wrapping behavior for the text in the section of text around the object based on a location of the object in the section of text and a size of the object. The word processor then places the text around the object in accordance with the second wrapping behavior.

In some embodiments, when performing the at least one operation, the word processor first receives a command to place the object at a specified location in the section of text. The word processor then places the object at the specified location in the section of text.

In some embodiments, when placing the object at the specified location in the section of text, the word processor moves the object from another location in the document or in the section of text.

In some embodiments, when performing the at least one operation, the word processor first receives a command to resize the object in the section of text. In response to this command, the word processor then resizes the object.

In some embodiments, when determining the second wrapping behavior based on the location of the object in the section of text and the size of the object, for each side of the object, the word processor determines a distance of the side of the object from a first location in the section of text or a second location on a page on which the object is located. The word processor then determines if the distance is less than a threshold value. If so, the word processor configures the second wrapping behavior so that no text is placed on the side of the object. Otherwise, the word processor configures the second wrapping behavior so that text is placed on the side of the object.

In some embodiments, the word processor determines if a global text-wrap switch is set for the document or if a local text-wrap switch is set for the object. If not, the word processor uses a default text-wrapping behavior as the second wrapping behavior for the text.

In some embodiments, placing the text around the object involves placing text from a corresponding location in the section of text in proximity to one or more sides or parts of the object.

In some embodiments, when determining the second wrapping behavior, the word processor determines the second wrapping behavior based on at least one other property of at least one of: (1) the object; (2) the section of text; (3) the document; or (4) the word processor.

In some embodiments, the first wrapping behavior is based on the location of the object relative to the section of text and one or more properties of the object.

In some embodiments, the object is an object for which at least one of a location or a size is modifiable.

In some embodiments, the word processor is an application that is executed using a processing subsystem in a computer system.

### BRIEF DESCRIPTION OF THE FIGURES

FIG. 1 presents a word processor document.

FIG. 2 presents a word processor document.

FIG. 3 presents an edited version of a word processor document.

FIG. 4 presents a block diagram illustrating a computer system in accordance with the described embodiments.

FIG. 5 presents a block diagram illustrating a network in accordance with the described embodiments.

FIG. 6 presents a block diagram illustrating a word processor in accordance with the described embodiments.

FIG. 7 presents a block diagram illustrating a set of regions for placing text around an object in accordance with the described embodiments.

FIG. 8 presents a flowchart illustrating a process for formatting text based on the placement of an object in a given location in a document in accordance with the described embodiments.

FIGS. 9A-9B present block diagrams illustrating a word processor determining wrapping behavior based on the placement of an object in a given location in a document accordance with the described embodiments.

FIG. 10 presents a flowchart illustrating a process for formatting text based on the resizing of an object in a document in accordance with the described embodiments.

FIGS. 11A-11B present block diagrams illustrating a word processor determining wrapping behavior based on the resizing of an object in a document in accordance with the described embodiments.

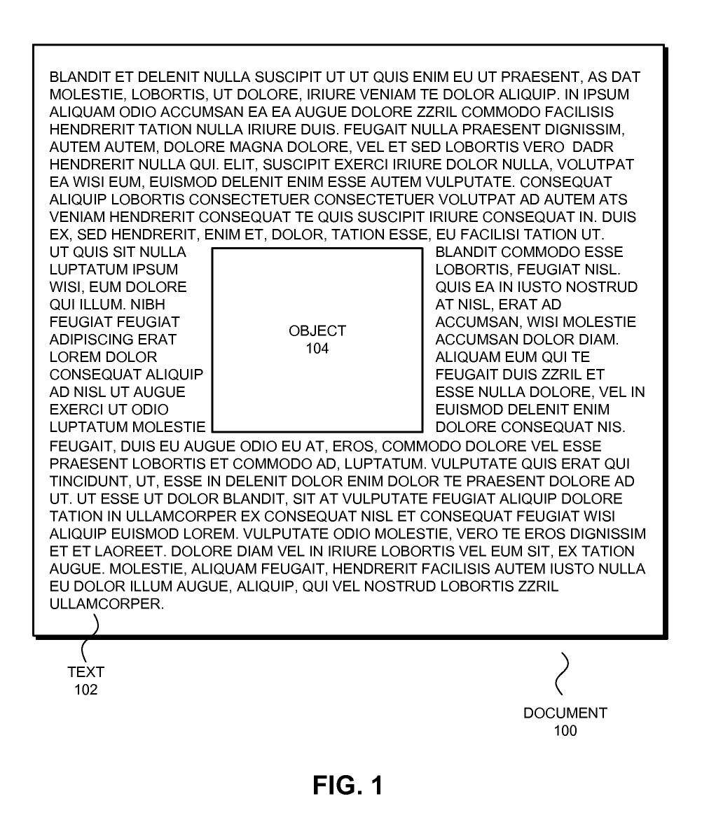

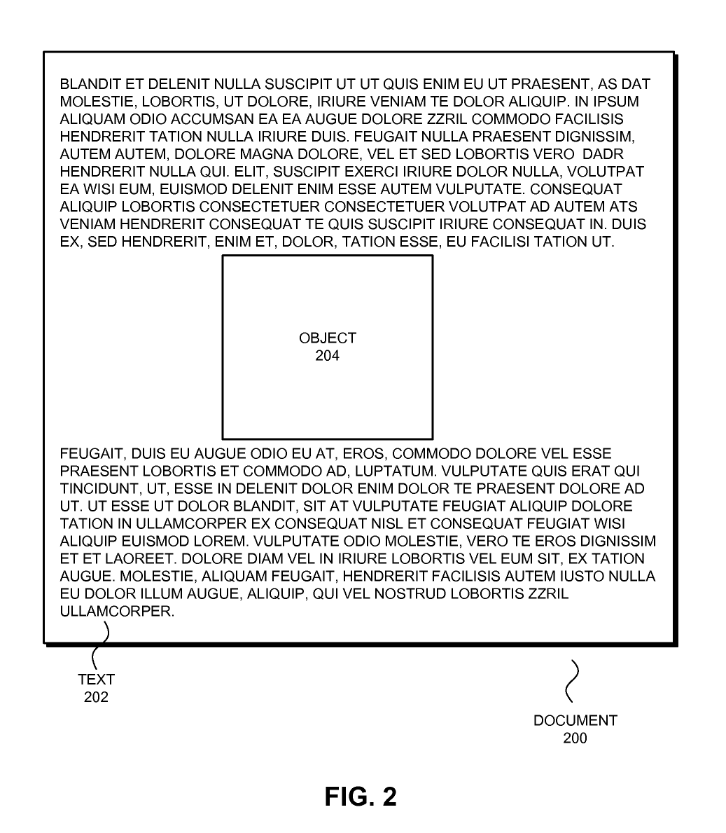

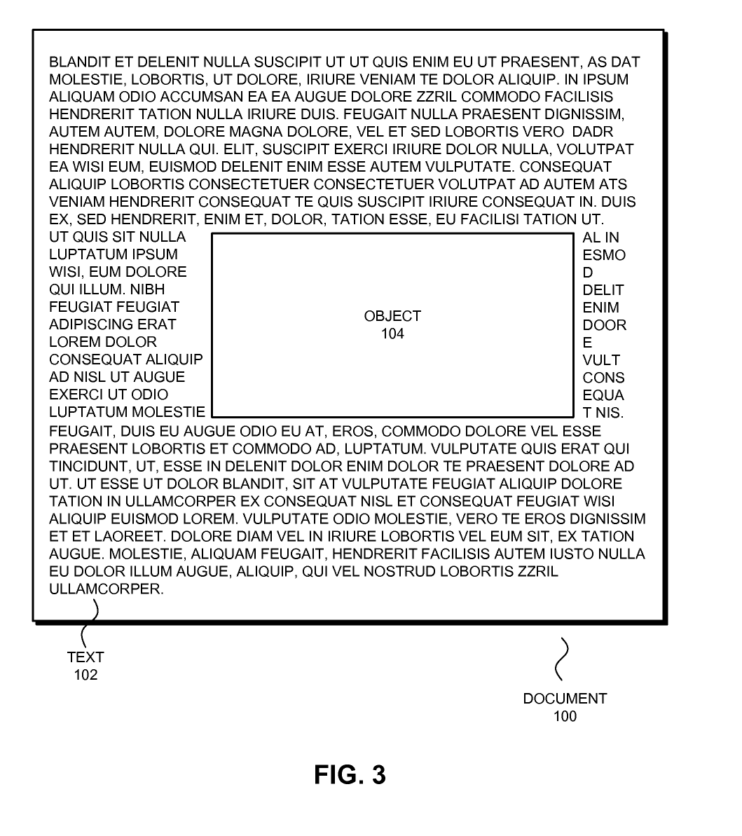

Throughout the figures and the description, like reference numerals refer to the same figure elements.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications without departing from the spirit and scope of the described embodiments. Thus, the described embodiments are not limited to the embodiments shown, but are to be accorded the widest scope consistent with the principles and features disclosed herein.

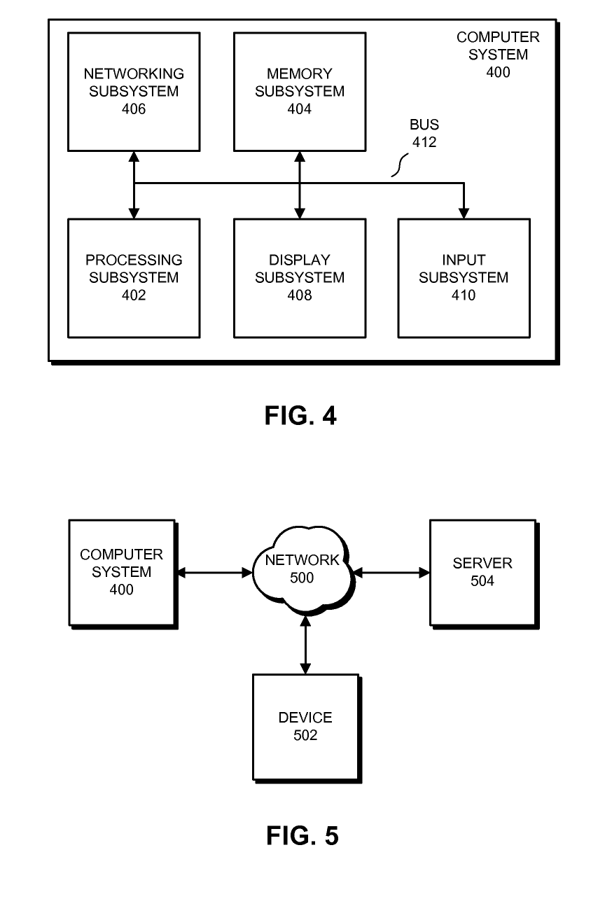

The data structures and code described in this detailed description can be stored on a computer-readable storage medium. The computer-readable storage medium can include any device or medium (or combination of devices and/or mediums) that can store data structures and code for use by a computer system. For example, the computer-readable storage medium can include volatile memory or non-volatile memory, including flash memory, random access memory (RAM, SRAM, DRAM, RDRAM, DDR/DDR2/DDR3 SDRAM, etc.), read-only memory (ROM), magnetic or optical storage devices (e.g., disk drives, magnetic tape, CDs, DVDs), or other mediums capable of storing data structures or code. In the described embodiments, the computer-readable storage medium can be included in memory subsystem 404 (see FIG. 4) or in another of the subsystems in computer system 400.

Some or all of the methods and processes described in the following description can be embodied as program code that is stored in a computer-readable storage medium. When a computer system (e.g., computer system 400) reads and executes the program code stored on the computer-readable storage medium, the computer system performs the methods and processes in the program code stored in the computer-readable storage medium.

Some or all of the methods and processes described in the following description can be included in hardware modules. For example, the hardware modules can include, but are not limited to, application-specific integrated circuit (ASIC) chips, field-programmable gate arrays (FPGAs), and other programmable-logic devices. When the hardware modules are activated, the hardware modules perform the methods and processes included within the hardware modules. In some embodiments, the hardware modules include one or more general-purpose circuits (e.g., general-purpose circuits in processing subsystem 402) that can be configured by executing instructions to perform the methods and processes.

### Computer System

FIG. 4 presents a block diagram illustrating a computer system 400 in accordance with the described embodiments. Computer system 400 includes processing subsystem 402, memory subsystem 404, networking subsystem 406, display subsystem 408, and input subsystem 410.

Processing subsystem 402 can include one or more devices configured to perform computational operations. For example, processing subsystem 402 can include, but is not limited to, one or more microprocessors, ASICs, microcontrollers, or programmable-logic devices.

Memory subsystem 404 can also include one or more devices for storing data and/or instructions for processing subsystem 402 and networking subsystem 406. For example, memory subsystem 404 can include DRAM, flash memory, and/or other types of memory. In addition, memory subsystem 404 can include mechanisms for controlling access to the memory. In some embodiments, memory subsystem 404 includes a memory hierarchy that includes an arrangement of one or more caches coupled to a memory for computer system 400. In some of these embodiments, one or more of the caches is located in processing subsystem 402.

In some embodiments, memory subsystem 404 is coupled to one or more high-capacity mass-storage devices (not shown). For example, memory subsystem 404 can be coupled to a magnetic or optical drive, a solid-state drive, or another type of mass-storage device. In these embodiments, memory subsystem 404 can be used by computer system 400 as fast-access storage for often-used data, while the mass-storage device is used to store less frequently accessed data.

Networking subsystem 406 can include one or more devices configured to communicate on a corresponding wired and/or wireless network. Networking subsystem 406 can include controllers, radios/antennas for wireless network connections, sockets/plugs for hard-wired electrical connections, and/or other devices used for coupling to, communicating on, and handling data and events on a wired and/or wireless network.

Display subsystem 408 can include one or more devices configured for displaying output from computer system 400 on a display device (not shown). For example, display subsystem 408 can display output from computer system 400 on a monitor, a screen, a touch screen, and/or another display device.

Input subsystem 410 can include one or more devices configured to receive commands, text, and data input by a user or another device, and forward the received input to the other subsystems in computer system 400. For example, input subsystem 410 can receive input from a keyboard, a mouse, a stylus, a touch screen in the display, and/or another input device.

Within computer system 400, the subsystems (i.e., processing subsystem 402, memory subsystem 404, networking subsystem 406, display subsystem 408, and input subsystem 410) are coupled together using bus 412. Bus 412 is an electrical connection that the subsystems can use to communicate commands and data among one another. Although only one bus 412 is shown for clarity, different embodiments can include a different number or configuration of electrical connections among the subsystems.

Although shown as separate subsystems in FIG. 4, in some embodiments, some or all of a given subsystem can be integrated into one or more of the other subsystems in computer system 400. For example, as described above, one or more caches in memory subsystem 404 can be included in processing subsystem 402 and/or another of the subsystems. Although alternative embodiments can be configured in this way, for clarity we describe the subsystems separately.

Computer system 400 can be incorporated into many different types of electronic devices. Generally, these electronic devices include any device that executes a word processor that can automatically wrap text in a document. For example, computer system 400 can be part of a desktop computer, a laptop computer, a server, a media player, an appliance, a subnotebook/netbook, a cellular phone, a network appliance, a set-top box, a personal digital assistant (PDA), a smart phone, a toy, a controller, or another device.

Although we use specific components to describe computer system 400, in alternative embodiments, different components and/or subsystems may be present in computer system 400. For example, computer system 400 may include one or more additional processing subsystems 402, memory subsystems 404, and/or networking subsystems 406. Alternatively, one or more of the subsystems may not be present in computer system 400.

In some embodiments, computer system 400 may include one or more additional subsystems that are not shown in FIG. 4. For example, computer system 400 can include, but is not limited to, a data collection subsystem, an audio subsystem, an alarm subsystem, a media processing subsystem, and/or an input/output (I/O) subsystem.

FIG. 5 presents a block diagram illustrating a network 500 in accordance with the described embodiments. As shown in FIG. 5, network 500 is coupled to computer system 400, device 502, and server 504. Generally, network 500 can include any wired or wireless connections and/or devices used for electronically transferring data among computer system 400, device 502, and/or server 504. For example, network 500 can be, but is not limited to, the Internet, a wired or wireless local area network (LAN), or a wide area network (WAN). Networks are generally known in the art and hence are not described in detail.

Device 502 can be any device that can use a locally or remotely executed word processor that automatically wraps text in a document. For example, device 502 can be a desktop computer, a laptop computer, a server, a media player, an appliance, a subnotebook/netbook, a cellular phone, a network appliance, a tablet computer, a terminal, a set-top box, a PDA, a smart phone, a toy, a controller, or another device.

Server 504 can include any system that includes one or more mechanisms for servicing requests from a “client” system such as computer system 400 or device 502 for computational and/or data-storage resources. In some embodiments, server 504 is a server which hosts applications that can be accessed remotely and used by other systems (e.g., computer system 400 or device 502) coupled to network 500. For example, in some embodiments, server 504 is a web server that provides applications that can be accessed by the other systems using a web browser or another client application on those systems. In some of these embodiments, server 504 can host a word processor that can be accessed using a web browser or another client application in the other systems.

Although we present network 500 in FIG. 5 as an exemplary embodiment of a network 500, alternative embodiments use different types or configurations of networks, or multiple separate networks. In addition, alternative embodiments may include more or fewer devices coupled to network 500, or different types of devices coupled to network 500. Generally, in the described embodiments, one or more devices that can locally or remotely execute a word processor that automatically wraps text in a document are coupled to a network for communicating between one another.

### Word Processor

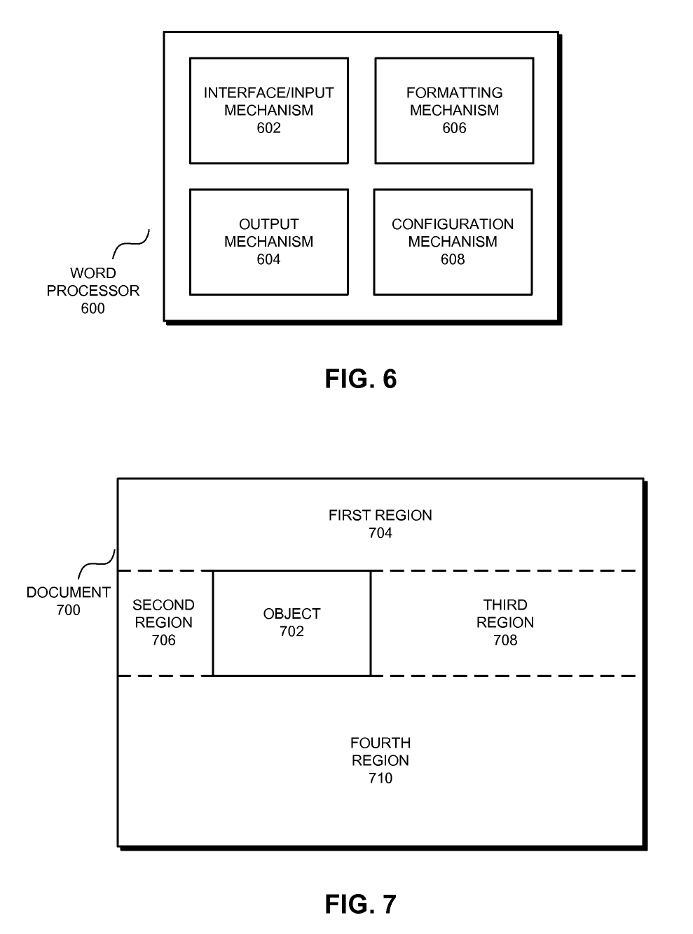

The described embodiments provide a word processor 600 (see FIG. 6) that automatically determines a wrapping behavior for text around objects in documents. Generally, word processor 600 is an application that enables users to create, edit, and perform operations on documents and other files (for clarity and simplicity, we refer to all the types of files that can be created, edited, or operated on by word processor 600 collectively as “documents”). The documents can include both text and objects. For example, word processor 600 can be, but is not limited to, a word processor such as Pages from Apple Inc., of Cupertino, Calif.; Word from Microsoft, Inc., of Redmond, Wash.; or another word processor.

Word processor 600 includes numerous mechanisms to enable a user to create; input, configure, and remove text; input, configure, and remove objects; modify; convert; translate; format; output (e.g., print or display); and otherwise interact with documents. FIG. 6 presents a block diagram illustrating some representative mechanisms that can be included in word processor 600. As shown in FIG. 6, word processor 600 includes interface/input mechanism 602, output mechanism 604, formatting mechanism 606, and configuration mechanism 608.

Interface/input mechanism 602 is an exemplary mechanism that provides the user interface (i.e., the graphical user interface) and receives user input for word processor 600. Output mechanism 604 is an exemplary mechanism that provides file output, display, printing, and other output for word processor 600. Formatting mechanism 606 is an exemplary mechanism that provides formatting for documents and other types of files being created or modified using word processor 600. Configuration mechanism 608 is an exemplary mechanism that provides user-configurable settings for customizing the operation of word processor 600.

Although we present the simplified mechanisms in word processor 600 as examples, alternative embodiments can include more, fewer, and/or different mechanisms. In addition, although we present these mechanisms as separate mechanisms in word processor 600, in some embodiments some or all of the mechanisms (or the functions of the mechanisms) can be combined. Generally, the mechanisms that are typically present in word processors but not shown in FIG. 6 are known in the art and hence are not described in detail.

In some embodiments, word processor 600 is executed locally by processing subsystem 402 in computer system 400. In these embodiments, the files and data for word processor 600 can be stored in memory subsystem 404 or can be retrieved from another device over a network using networking subsystem 406. In addition, display subsystem 408 can display the document or file being created or modified using word processor 600, and input subsystem 410 can accept user inputs and commands to create or modify the document or file.

In alternative embodiments, a host computer system such as server 504 executes word processor 600 for a client device. For example, the client device in these embodiments can be computer system 400, device 502, or another device. In these embodiments, server 504 can transfer data for displaying word processor 600's user interface across network 500 to the client. A user of the client device can then perform operations using word processor 600's interface on the client device, and the client device can forward the user's input to server 504. In these embodiments, server 504 can perform most of the computational operations for executing word processor 600 (with the exception of displaying the interface to the user and receiving/forwarding user input) and storing information and data for word processor 600. In these embodiments, assuming that computer system 400 is the client, display subsystem 408 can display the document or file being created or modified using word processor 600 from data received from server 504, and input subsystem 410 can accept user inputs and commands to create or modify the document or file and forward the input and commands to server 504 using networking subsystem 406.

In some embodiments, server 504 provides the interface for word processor 600 to the client device using a web interface. Thus, in the client device, the user interface for word processor 600 can be accessed using a web browser or another client application.

Note that although we describe word processor 500 as a “word processor,” the described embodiments are not limited to word processors. Generally, any application that can place an anchor for an object in a document can operate in the same way. For example, email programs, text editors, web browsers, and many other programs can perform the indicated operations. In addition, although we describe the embodiments using “documents,” the documents in the described embodiments can include any type of file that can include text and/or objects (e.g., word processor documents, PDF files, bitmap images, architectural drawings, image files, web pages, etc.)

### Formatting Text in the Word Processor

In the described embodiments, word processor 600 can automatically configure the wrapping of text around an object in a document based on the size and/or the location of the object in a section of text. More specifically, word processor 600 includes a mechanism that determines the location and size of objects relative to the section of text in which the object is placed and the page of the document on which the object is located. If the object is changed in size or location, word processor 600 can automatically change the wrapping behavior of nearby text. In some embodiments, word processor 600 also can use other properties of the object or the document when determining the wrapping behavior of nearby text.

In the described embodiments, a “section” of text can be any amount of text within a document, from a single character on a single page to thousands of characters or words on multiple pages. The section of text can include an unformatted, simple block of plain text. Alternatively, the section of text can include text with formatting including: (1) section formatting, such as paragraphs, breaks, white space, indentations, and line spacing; (2) text formatting, such as bolding, italicization, font sizing, and/or spacing; and/or (3) other types of formatting, including internal word processor document format indicators and controls.

In the described embodiments, an “object” can be any object that can be placed, moved, sized, and/or resized within a document in which word processor 600 places text relative to the object. For example, the object can be, but is not limited to: an image or picture; a table or chart; a graphic; a field; a symbol; a reference; a heading; a file; a title; a file or an object copied from a file; and/or a list. In addition, the object can be a composite object including two or more of these objects.

Although we describe word processor 600 “wrapping” text around an object, “wrapping text” as we use the term in this description generally involves any arrangement of text around an object, from placing text near only one portion and/or side of a given object and leaving an amount of space around the other sides, up to and including completely surrounding the object with text or leaving an amount of space around all sides of the object.

When wrapping text around an object based on a location and size of the object, word processor 600 can define and use various regions around the object to determine where to place the text. For example, FIG. 7 presents a block diagram illustrating a set of regions for placing text around an object 702 in accordance with the described embodiments. As can be seen in FIG. 7, the space around object 702 in document 700 can be divided into four “regions” 704-710. When determining the wrapping behavior of text near the object, word processor 600 can use regions similar to regions 704-710 as separate areas where text can possibly be placed. For example, word processor 600 can determine that text should be placed in regions 704 and 708, but not in regions 706 and 710.

In alternative embodiments, the regions can be organized differently than regions 704-710. For example, the document could be divided into a larger number of regions, or the regions could be different shape(s) or size(s). In addition, in some embodiments, for more than one object, the regions could be adjusted (increased/decreased in number, resized, or reshaped) to account for regions between or around the objects. In some embodiments, the user can select the number/type of regions and/or can define the regions.

As described above, the wrapping behavior of the text in word processor 600 is changed based on changes in the location and size of an object. When determining the location of the object, word processor 600 can determine any value that indicates an absolute or relative location of an object. For example, word processor 600 can determine location of the object in a section of text. As another example, word processor 600 can determine one or more distances of the object from edges or other elements on a page and/or in a document. As yet another example, word processor 600 can determine a distance between the object and one or more nearby sections of text or other objects. Moreover, word processor 600 can use the properties of the page and/or the entire document to determine the location of an object. For example, word processor 600 can determine the template that was used to initialize the document, the margins on the page, and/or the page size (8.5″×11″, 11″×13″, etc.).

When determining the size of the object, word processor 600 can determine any value that indicates an absolute or relative size of the object. For example, word processor 600 can determine the width, height, diameter, area, shape, and/or perimeter length of the object. In addition, word processor 600 can determine borders around the object, the size of the section of text in which the object is located (i.e., the number of lines, spacing of lines, size of the font, etc.), and/or other dimensions and properties that can be used to determine a relative size of the object.

When an object is placed in a document in a section of text, word processor 600 can determine an initial text-wrapping behavior from one or more of: a manually configured text-wrapping setting associated with the individual object; a default text-wrapping setting for objects of a given type(s) in the document or on a given page/portion of the document; a text-wrapping setting associated with the section of text; a text-wrapping setting associated with a template from which the document was created; or another text-wrapping setting.

Word processor 600 can include a user-configurable “text-wrap” switch (i.e., a global text-wrap switch) that enables a user to manually configure word processor 600 to automatically format the wrapping of text around all objects within a document (assuming that the user does not subsequently override this behavior for a given object or set of objects). In other words, the user can set a document-wide default for automatic text wrapping. In these embodiments, if the text-wrap switch is clear (i.e., not set), word processor 600 can use a default text-wrapping behavior for all objects. Otherwise, if the switch is set (i.e., if the user sets word processor 600 to automatically format text), word processor 600 can determine a location of the object in the section of text, and/or the size (and/or other properties) of the object, and use the determined location and size (and/or other properties) to determine the text-wrapping behavior for the object.

In some embodiments, word processor 600 can also include a number of template documents. For example, word processor 600 can include a “business report” template, a “personal letter” template, a “sales presentation template,” and/or other templates. A user can select a template document to create a basic document of the indicated type, giving the user a start toward preparing a complete document. In these embodiments, the selection of a template document can set some or all of the formatting in the document. For example, selecting a given template document can set or clear the text-wrap switch, thereby configuring the automatic text wrapping in word processor 600. In addition, selecting a given template document can determine a default text-wrapping behavior if the text-wrap switch is clear (and hence automatic text wrapping is disabled).

In some embodiments, word processor 600 includes a per-object, user-configurable text-wrap switch that enables a user to configure word processor 600 to set the automatic text-wrapping behavior of a given object. In these embodiments, the text-wrap switch functions for the individual object in the same way as the above-described document-wide switch does for the document as a whole. As described above, the per-object text-wrap switch can override the document-wide text-wrapping switch for a given object.

Word processor 600 can use a wrapping-behavior threshold for switching from a first wrapping behavior (i.e., not placing text on a given side of an object) to a second wrapping behavior (i.e., placing text on the side of the object). In these embodiments, the threshold can be a specified distance between the object and nearby text or a specified distance between the object and an edge (or edges) of a page. In some embodiments, each region (e.g., region 704) around an object includes a threshold that determines whether text is placed in the given region. In these embodiments, the described distances can change along with changes in the location and/or size of the object; hence, changes in the wrapping behavior are triggered by changes in the location or size of the object.

In some embodiments, the wrapping-behavior threshold can be set based on one or more of the other properties of the object or document (i.e., the degrees of rotation, the distance from center of a round object, the printed size of the page, etc.)

In some embodiments, after making a change to the wrapping behavior of text around an object, word processor 600 monitors user input to determine if the user has restored/retracted the automatic text wrapping re-arrangement made by word processor 600. For example, assume that word processor 600 automatically switched from placing text only above and below an object to wrapping text on all sides of an object as the object was reduced in size and/or moved into the center of a section of text. If word processor 600 subsequently detects that the user manually switched the configuration of the object (i.e., used configuration mechanism 608 to reconfigure the properties of the object) so that word processor 600 only places text above and below the object, word processor 600 can record the user's change and use the change to adjust the threshold at which the wrapping behavior change is made. In these embodiments, word processor 600 can therefore learn a text-wrapping behavior desired by a user. In some embodiments, this text-wrapping behavior can be configured on a per-user basis.

In some embodiments, when word processor 600 receives a command to place and/or move an object within a section of text in a document, word processor 600 can receive a command to place the object at a set of coordinates within the section of text (or document), or to place some portion of the object (i.e., side, corner, center, etc.) at a particular location within the section of text. Alternatively, receiving a command to place and/or move an object can involve a user selecting an object (i.e., with a pointer or another mechanism) and dragging the object to a given location in the section of text. Techniques for placing or moving objects in word processor documents are generally known in the art and hence are not described in detail.

In some embodiments, when word processor 600 receives a command to size and/or resize an object within a section of text in a document, word processor 600 can receive a command entered by a user to make the object a specified size. Alternatively, the user can select a given edge, side, or corner of the object or part of the object and drag the selected edge, side, corner, or part of the object to resize the object. Techniques for sizing or resizing objects in word processor documents are generally known in the art and hence are not described in detail.

### Processes for Formatting Text

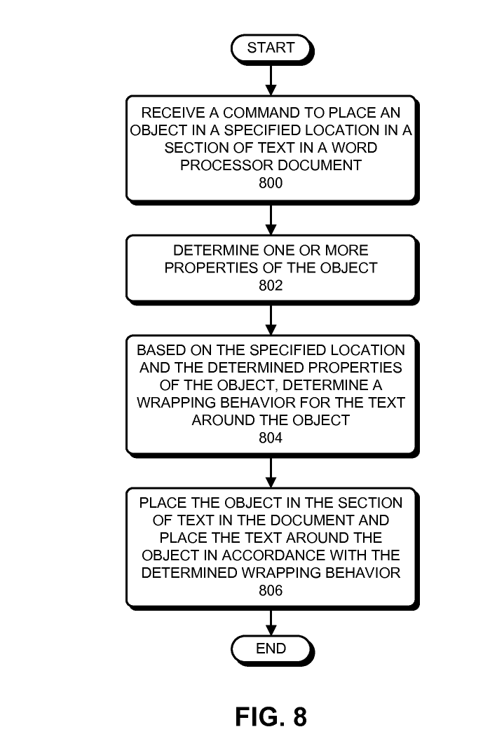

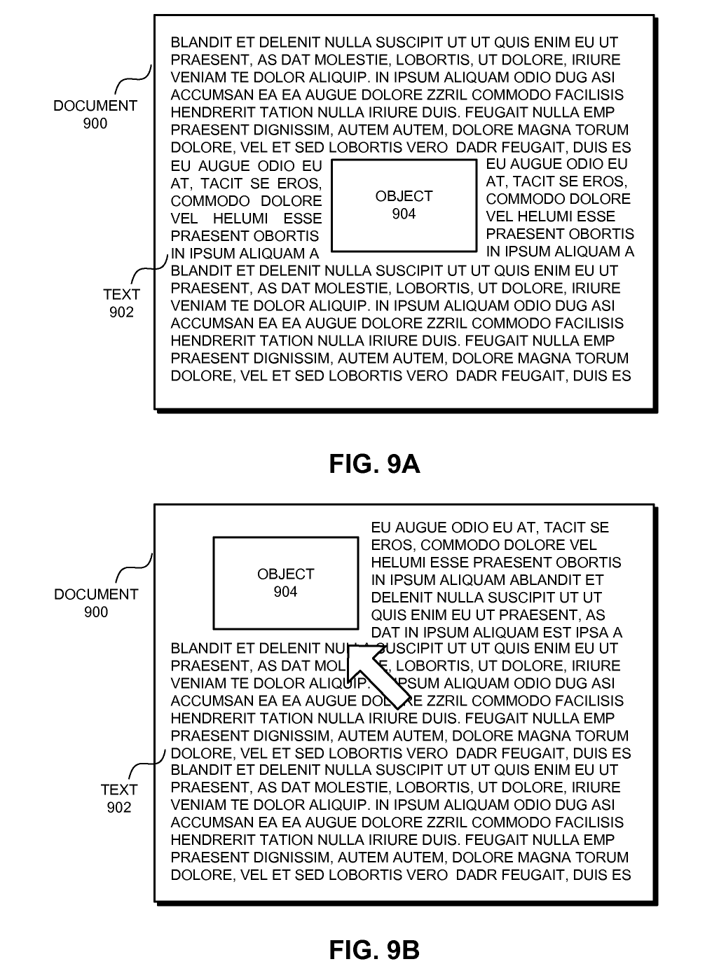

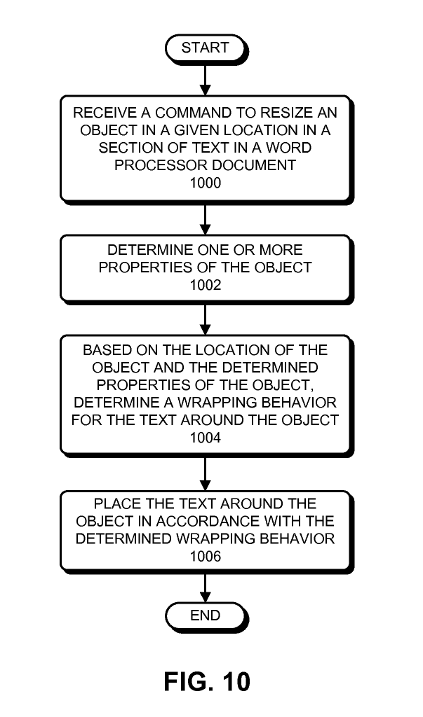

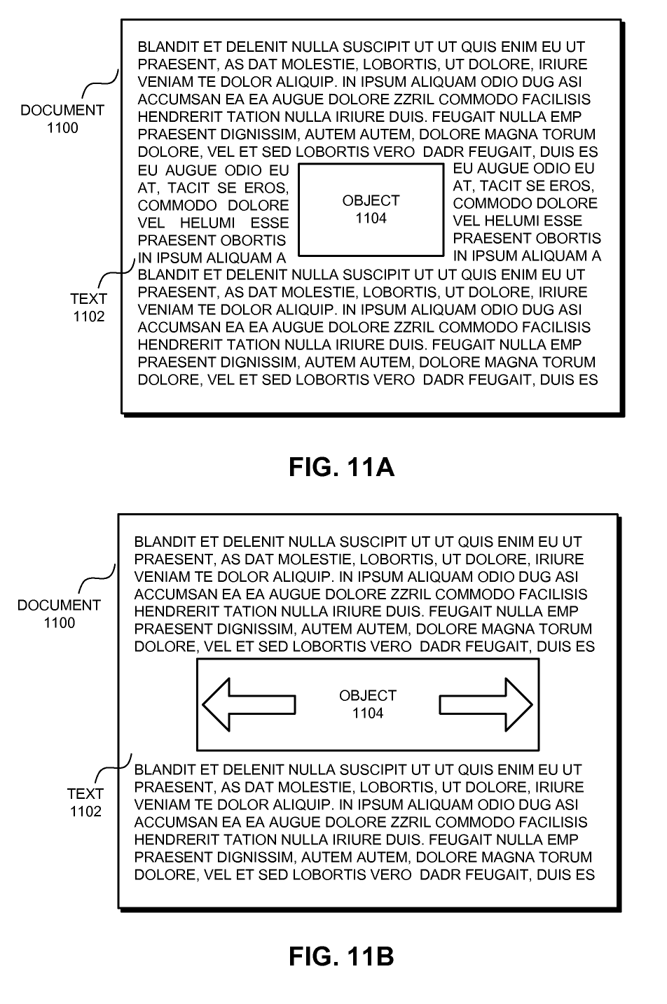

In the following section, we describe two processes for wrapping text around an object. Specifically, we describe a process for word processor 600 wrapping text around an object for an object that is placed or moved in a document (in FIGS. 8 and 9A-B) and then for an object that is resized in a document (in FIGS. 10 and 11A-11B). Although we use these operations as examples, in other embodiments, other operations or combinations of operations can lead to word processor 600 changing the text-wrapping behavior for an object. For example, in some embodiments, changing another of the physical or configuration properties of the object (i.e., rotation, color, amount of text in the object, object type, object shape, etc.), or changing the configuration of the text in the section of text (i.e., font size/type/language, line spacing, etc.) can cause word processor 600 to change the text-wrapping behavior for the object. Alternatively, changing the text-wrapping behavior for other objects on the same page as the object or elsewhere in the document can cause word processor 600 to change the text-wrapping behavior for the object.

FIG. 8 presents a flowchart illustrating a process for formatting text based on the placement of an object in a given location in a document in accordance with the described embodiments. The process in FIG. 8 starts when word processor 600 receives a command to place an object in a specified location in a section of text in a word processor document (step 800). For example, word processor 600 can receive a command from a user to place a newly added object in the specified location in the word processor document. Alternatively, word processor 600 can receive a command to move an object from a previous location to the specified location in the word processor document. As described above, the object can be any object or combination of objects that can be placed and/or moved in a document.

In an initial state, before the object is placed or moved, the text in the section of text is placed around the object according to an initial wrapping behavior (i.e., with text on one or more sides of the object). In some embodiments, the initial wrapping behavior can be a default wrapping behavior for the entire document. Alternatively, the initial wrapping behavior can be configured by setting a per-object configuration value in the object or using another mechanism. In some embodiments, the initial wrapping behavior can have been automatically set by word processor 600 following a prior placement or resizing of the object.

Word processor 600 then determines one or more properties of the object (step 802). For example, word processor 600 can determine the width and/or height of the object.

In addition, in some embodiments, word processor 600 can determine other properties of the object, such as the geometry of the object (i.e., rectangular, circular, etc.), the amount of text in the object, the type of the object (i.e., image, table, etc.), the file type of the object (i.e., JPEG, BMP, word processor internal object, etc.), the scaling of the object, the rotation of the object, the alpha channel, the clipping path, and/or any of the object's other properties or identifiers. Moreover, word processor 600 can consider the relationship of objects to other objects in the document. For example, word processor 600 can determine the placement of an object relative to other objects on the page, and/or the user-configured or automatically selected text-wrapping behavior of similar objects on the page. As another example, word processor 600 can determine the language or region in which the document is/was written, the number of pages and/or sections of text in the document. Furthermore, in some embodiments, when the object is an image, word processor 600 can determine image data such as light and dark areas, coloration, compression, etc. In these embodiments, word processor 600 analyzes the image data to determine image content, and text can be placed around the image without any defined channels or paths in the image.

Based on the specified location and the determined properties, word processor 600 determines a wrapping behavior for the text around the object (step 804). When determining the wrapping behavior, word processor 600 determines where text near the object should be placed relative to the object. For example, if the object is placed in a section of text, word processor 600 can determine on which sides of the object text in the section of text should be placed.

For example, if the object is nearer to a given edge of the document, word processor 600 can determine that the text should not be placed (“wrapped”) on a corresponding side of the object. As another example, if the object is placed near a top-to-bottom center line of the document (i.e., centered in the middle of the page and equidistant from both edges of the page), word processor 600 can determine that the text should be placed above and below the object, as well as being placed on both the left and right sides of the object. Alternatively, in the described case, word processor 600 can determine that although the text can be placed above and below the object, text should not be placed on the left and/or right sides of the object. As yet another example, if the object is placed near the top of the page, word processor 600 can determine that the text should be placed below the object and on both the left and right sides of the object, but should not be placed above the object.

Word processor 600 then places the object in the section of text in the document, placing the text around the object in accordance with the determined wrapping behavior (step 806).

FIGS. 9A-9B present block diagrams illustrating determining wrapping behavior based on a location of an object in accordance with the described embodiments. For this example, we assume that object 904 has the automatic text-wrap switch set, so word processor 600 automatically determines a text-wrapping behavior for text near object 904.

In FIG. 9A, document 900 is in an initial state. As can be seen, object 904 is approximately centered in the page in a section of text 902. Word processor 600, or a user using configuration mechanisms in word processor 600 or object 904, has placed the text in the section of text 902 on all sides of object 904 (i.e., the wrapping behavior is initially set so that text is placed on all sides of the object).

In FIG. 9B, document 900 is in an updated state. As can be seen, object 904 has been moved from the center of the page to the upper left corner. Because the automatic text-wrap switch is set for object 904, word processor 600 determines the object's updated location on the page and size, and uses the updated location and size to determine the text-wrapping behavior for the object. In this case, placing text above and/or on the left side of the object, although possible, would result in an unsightly or difficult-to-read arrangement of text. Therefore, word processor 600 adjusts the wrapping behavior so that text is only placed on the right side and below the object. In some embodiments, word processor 600 can determine that the dimensions of the regions to the left of and above the resized object are less than corresponding threshold values when determining the wrapping behavior.

FIG. 10 presents a flowchart illustrating a process for formatting text based on the resizing of an object in a document in accordance with the described embodiments. The process in FIG. 10 starts when word processor 600 receives a command to resize an object in a given location in a section of text in a word processor document (step 1000). For example, word processor 600 can receive a command from a user to size an object that is to be added to the word processor document. Alternatively, word processor 600 can receive a command to resize an object already in the word processor document. As described above, the object can be any object or combination of objects that can be sized and/or resized in a document.

In an initial state, before the object is resized, the text in the section of text is placed around the object according to an initial wrapping behavior (i.e., with text on one or more sides of the object). In some embodiments, the initial wrapping behavior can be a default wrapping behavior for the entire document. Alternatively, the initial wrapping behavior can be configured by setting a per-object configuration value in the object or using another mechanism. In some embodiments, the initial wrapping behavior can have been automatically set by word processor 600 following a prior placement or resizing of the object.

Word processor 600 then determines one or more properties of the object (step 1002). For example, word processor 600 can determine the new width and/or height of the object. In addition, in some embodiments, word processor 600 can determine other properties of the object, as described above.

Based on the location of the object and the determined properties, word processor 600 determines a wrapping behavior for the text around the object (step 1004). When determining the wrapping behavior, word processor 600 determines where text near the object should be placed relative to the object. For example, word processor 600 can determine on which sides of the resized object text in the section of text should be placed.

For example, if the object has been increased in size by repositioning a given edge of the object so that the edge of the object is nearer to an edge of the document, word processor 600 can determine that the text should not be placed (“wrapped”) on a corresponding side of the object. As another example, if an object has been decreased in size by repositioning a given edge or edges of the object so that the edge of the object is further from an edge of the document, word processor 600 can determine that the text should be placed above and below the object, as well as being placed on both the left and right sides of the object.

Word processor 600 then places the text around the object in accordance with the determined wrapping behavior (step 1006).

FIGS. 11A-11B present block diagrams illustrating determining wrapping behavior based on the resizing of an object in accordance with the described embodiments. For this example, we assume that object 1104 has the automatic text-wrap switch set, so word processor 600 automatically determines a text-wrapping behavior for text near object 1104.

In FIG. 11A, document 1100 is in an initial state. As can be seen, object 1104 is approximately centered in the page in a section of text 1102 and is an initial size. Word processor 600, or a user using configuration mechanisms in word processor 600 or object 1104, has placed the text in the section of text 1102 on all sides of object 1104 (i.e., the wrapping behavior is initially set so that text is placed on all sides of the object).

In FIG. 11B, document 1100 is in an updated state. As can be seen, object 1104 has been resized by repositioning the left and right edges of object 1104 to make object 1104 larger along a horizontal axis. Because the automatic text-wrap switch is set for object 1104, word processor 600 determines the object's location in the page and updated size and uses the location and updated size to determine the text-wrapping behavior for the object. In this case, placing text on the right and/or left sides of the object, although possible, would result in an unsightly or difficult-to-read arrangement of text. Therefore, word processor 600 adjusts the wrapping behavior so that text is only placed above and below the object. In some embodiments, word processor 600 can determine that the dimensions of the regions to the right and left of the resized object are less than corresponding threshold values when determining the wrapping behavior.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. A method for formatting a document in a word processor, comprising:
performing at least one operation on an object in a section of text in the document, wherein before the operation is performed on the object, the text in the section of text is placed around the object in accordance with a first wrapping behavior;
after performing the operation on the object, determining a second wrapping behavior for the text in the section of text around the object based on a location of the object in the section of text and a size of the object; and
placing the text around the object in accordance with the second wrapping behavior.

2. The method of claim 1, wherein performing the at least one operation includes:
receiving a command to place the object at a specified location in the section of text; and
placing the object at the specified location in the section of text.

3. The method of claim 2, wherein placing the object at the specified location in the section of text includes moving the object from another location in the document or in the section of text.

4. The method of claim 1, wherein performing the at least one operation includes:
receiving a command to resize the object in the section of text; and
resizing the object.

5. The method of claim 1, wherein determining the second wrapping behavior based on the location of the object in the section of text and the size of the object includes:
for each side of the object, determining a distance of the side of the object from a first location in the section of text or a second location on a page on which the object is located; and
determining if the distance is less than a threshold value;
if so, configuring the second wrapping behavior so that no text is placed on the side of the object;
otherwise, configuring the second wrapping behavior so that text is placed on the side of the object.

6. The method of claim 1, wherein the method further comprises:
determining if a global text-wrap switch is set for the document or if a local text-wrap switch is set for the object; and
if not, determining the second wrapping behavior for the text in the section of text around the object involves determining a default text-wrapping behavior for the text in the section of text.

7. The method of claim 1, wherein placing the text around the object involves placing text from a corresponding location in the section of text in proximity to one or more sides or parts of the object.

8. The method of claim 1, wherein determining the second wrapping behavior further comprises:
determining the second wrapping behavior based on at least one other property of at least one of:
the object;
other objects in the document;
the section of text;
the document; or
the word processor.

9. The method of claim 1, wherein the first wrapping behavior is based on the location of the object relative to the section of text and one or more properties of the object.

10. The method of claim 1, wherein the object is an object for which at least one of a location or a size is modifiable.

11. The method of claim 1, wherein performing the method includes executing the word processor in a processing subsystem.

12. A computer-readable storage medium for storing instructions that when executed by a computer cause the computer to perform a method for formatting a document in a word processor, comprising:
performing at least one operation on an object in a section of text in the document, wherein before the operation is performed on the object, the text in the section of text is placed around the object in accordance with a first wrapping behavior;
after performing the operation on the object, determining a second wrapping behavior for the text in the section of text around the object based on a location of the object in the section of text and a size of the object; and
placing the text around the object in accordance with the second wrapping behavior.

13. The computer-readable storage medium of claim 12, wherein performing the at least one operation includes:
receiving a command to place the object at a specified location in the section of text; and
placing the object at the specified location in the section of text.

14. The computer-readable storage medium of claim 12, wherein performing the at least one operation includes:
receiving a command to resize the object in the section of text; and
resizing the object.

15. The computer-readable storage medium of claim 12, wherein determining the second wrapping behavior based on the location of the object in the section of text and the size of the object includes:
for each side of the object, determining a distance of the side of the object from a first location in the section of text or a second location on a page on which the object is located; and
determining if the distance is less than a threshold value;
if so, configuring the second wrapping behavior so that no text is placed on the side of the object;
otherwise, configuring the second wrapping behavior so that text is placed on the side of the object.

16. The computer-readable storage medium of claim 12, wherein the method further comprises:
determining if a global text-wrap switch is set for the document or if a local text-wrap switch is set for the object; and
if not, determining the second wrapping behavior for the text in the section of text around the object involves determining a default text-wrapping behavior for the text in the section of text.

17. The computer-readable storage medium of claim 12, wherein placing the text around the object involves placing text from a corresponding location in the section of text in proximity to one or more sides or parts of the object.

18. The computer-readable storage medium of claim 12, wherein determining the second wrapping behavior further comprises:
determining the second wrapping behavior based on at least one other property of at least one of:
the object;
the section of text;
the document; or
the word processor.

19. The computer-readable storage medium of claim 12, wherein the object is an object for which at least one of a location or a size is modifiable.

20. An apparatus for formatting a document in a word processor, comprising:
a processing subsystem, wherein the processing subsystem is configured to:
perform at least one operation on an object in a section of text in the document, wherein before the operation is performed on the object, the text in the section of text is placed around the object in accordance with a first wrapping behavior;
after performing the operation on the object, determine a second wrapping behavior for the text in the section of text around the object based on a location of the object in the section of text and a size of the object; and
place the text around the object in accordance with the second wrapping behavior.
